(19) United States
(12) Patent Application Publication
(10) Pub. No.: US 2009/0206007 A1
(43) Pub. Date: Aug. 20, 2009

(54) PROCESS AND APPARATUS FOR UPGRADING COAL USING SUPERCRITICAL WATER

(75) Inventor: Rodney John Allam, Chippenham (GB)

Correspondence Address: AIR PRODUCTS AND CHEMICALS, INC.;PATENT DEPARTMENT, 7201 HAMILTON BOULEVARD, ALLENTOWN, PA, 181951501, US

(73) Assignee: AIR PRODUCTS AND CHEMICALS, INC., Allentown, PA (US)

(21) Appl. No.: 12/033,961

(22) Filed: Feb. 20, 2008

(51) Int. Cl. C10G 1/00; B01J 19/00

(52) U.S. Cl. 208/415; 422/162

(57) ABSTRACT

Coal is converted into hydrocarbon compounds using supercritical water. The process involves two stages; a first stage in which carbonaceous material is reacted with supercritical water at above 850K to produce a first supercritical fluid reaction mixture comprising hydrocarbon compounds; and a second stage in which hydrocarbon compounds are extracted from coal mixed with at least a portion of the first supercritical fluid at a temperature within a range of from the supercritical temperature of water to about 695K. Char from the second stage is finely divided and may be either be used outside the process, e.g. in a coal fired power station or a gasifier, or used as at least a portion of the carbonaceous material used in the first stage.

### BACKGROUND OF THE INVENTION

The present invention relates to upgrading coal using supercritical water (“SCW”), i.e. using SCW to extract valuable products, e.g. “light” hydrocarbons, hydrogen and carbon monoxide, from coal. The invention may be applied to any type of coal but is particularly useful in upgrading coal having a high content of volatile components. Suitable coals include sub-bituminous coals and lignite.

The present methods of energy conversion using coal as the fossil fuel include combustion, gasification and separation into a metallurgical coke with production of volatile gaseous and liquid products by a process of pyrolysis. Combustion of coal as a pulverized fuel in steam boilers followed by Rankine cycle shaft power production is the primary source of electricity generation used in the world today. Partial oxidation of coal using pure oxygen at pressures in excess of 40 bar and temperatures above 1675K yields a synthesis gas (“syngas”) mixture (containing predominantly carbon monoxide and hydrogen) which can be used as a fuel gas in a gas turbine combined cycle power generation system, or as a raw material for the production of hydrogen, hydrocarbons and other chemicals by a variety of catalytic reactions.

An important consideration in all these processes is their environmental impact, particularly emissions of carbon dioxide; oxides of sulfur (e.g. sulfur dioxide and/or sulfur trioxide; “SOₓ”); oxides of nitrogen (e.g. nitric oxide and/or nitrogen dioxide; “NOₓ”); and trace components such as mercury, to the atmosphere. Direct coal combustion requires expensive means for removal of sulfur dioxide based on limestone slurry scrubbing of the flue gas. NOₓ can be removed by an expensive catalytic reduction at elevated temperatures, using hydrogen carriers such as ammonia, while carbon dioxide may be removed by processes involving scrubbing flue gas with an amine solution or by “oxyfuel” combustion processes. However, such processes add significantly, e.g. around 40%, to the cost of the generated electricity.

Coal gasification is a complex and expensive process involving high pressures and temperatures. The process has not been practiced widely. However, the process can produce clean hydrogen which can be used in a gas turbine combined cycle power generation. Alternatively, the process can produce syngas mixtures from which hydrocarbons and other chemicals can be made. The gasification process also removes sulfur as hydrogen sulfide and can easily be adapted to shift carbon monoxide to form carbon dioxide and to capture carbon dioxide for disposal.

There is, however, a need for a process for primary treatment of coal which can be used to produce products such as gaseous fuels; valuable hydrocarbon compounds; heat energy (which is easily convertible to electrical energy); and an easily-handled ash residue. The process should also remove pollutants such as sulfur compounds; heavy metals such as mercury; NOₓ; dust particles; carbon dioxide; and any other trace impurity emissions.

The use of SCW to upgrade coal has been suggested before. For example, U.S. Pat. No. 3,850,738 (Stewart, Jr. et al; published in 1974) discloses a process for the liquefaction of carbonaceous material such as bituminous or sub-bituminous coal. A slurry of comminuted coal is introduced into a reaction zone combining water under supercritical conditions and hydrogen. The coal is maintained under these conditions for sufficient time to decompose the coal by pyrolysis into a relatively low molecular weight liquid fraction. It is disclosed that the primary source of heat for the reaction is introduced by heating the feed water, elevating it to supercritical conditions. Additional heat is added to the reaction zone as a result of the exothermic nature of the reaction. The temperature of the heated water will usually be sufficient to bring the reaction medium to a temperature of at least 380° C. (˜650K) and no more than 650° C. (˜925K). The pressure in the reactor is usually from 3,300 psi to 10,000 psi (˜230 bar to ˜690 bar). Contact time in the reaction zone is usually from about 1 minute to about 10 minutes. After this time, the reaction mixture is transferred to a separation zone where solids are separated and recovered to be used as a fuel, a source of hydrogen or otherwise processed. The fluid stream is flashed into a condensing and heat exchanging zone where gaseous products including hydrogen and gaseous hydrocarbons such as methane are separated from the combined liquid phases which are then separated into aqueous and organic phases. The aqueous phase contains a major portion of low molecular weight sulfur and nitrogen containing compounds. The organic phase, containing a high yield of aromatic hydrocarbons, particularly aralkanes in the C₇-C₉ range, may be processed using conventional techniques such as fractional distillation.

U.S. Pat. No. 4,485,003 (Coenen et al; published in 1984) discloses a catalyzed hydrogenation process for producing liquid hydrocarbon compounds from coal. A slurry of comminuted coal having a particle size of 1 μm to 5 mm is treated with water at a temperature of 380° C. to 600° C. (˜650K to ˜875K) and at a pressure of 260 bar to 450 bar for 10 to 120 minutes. Hydrogen is added, together with a hydrogenation catalyst, simultaneously with the treatment with the water to form a charged supercritical phase containing hydrogenated organic compounds and a coal residue. Preferably, the coal residue is either used to generate energy or gasified to produce hydrogen for the hydrogenation. A heavy oil component is recycled to the slurry being fed to the supercritical reaction stage. Heat for the process is provided by pre-heating the reactor feed streams and by external heating of the reactor.

Studies have been carried out involving the combustion of coal particles in SCW/oxygen and the results of these studies have been published on the internet (“Combustion of coal particles in H₂O/O₂ supercritical fluid”, Vostrikov, A. A., Dubov D. Yu., Psarov S. A., and Sokol M. Ya., American Chemical Society, 27^{th} May 2007; and “Kinetics of coal conversion in supercritical water”, Vostrikov, A. A., Psarov S. A., Dubov D. Yu., Fedyaeva O. N., and Sokol M. Ya., American Chemical Society, 27^{th} May 2007). The disclosure of each of these publications is incorporated herein by reference.

In the studies described in the first of the two Vostrikov publications, spherical coal particles having a diameter of 1 mm to 5 mm were formed mechanically from coal from the Kuznetsk Basin. A particle was placed on a flat porous stainless steel disc in the centre of a vertical cylindrical reactor of 24 mm diameter. The reactor was filled with distilled, degassed water and heated to an operating temperature from 400° C. to 750° C. (˜675K to ˜1025K). A supercritical fluid containing water and oxygen was pumped through the reactor at the operating temperature of the reactor and at a pressure of 30 MPa (300 bar). After oxidation (which was usually fast, e.g. less than 5 seconds), the reaction was quenched with cold water.

The results indicated that, under the conditions studied, both gasification and oxidation of the coal particles occurred and that, if the mass share of oxygen in the supercritical fluid is 2-3%, then the rate of loss of particle mass by gasification is comparable to that by oxidation. With the assumption of zero order reaction with water concentration, the activation energy and pre-exponential factor for the rate of gasification by water were estimated as 19 kJ/mol and 1.02×10⁻² s⁻¹, respectively. It was determined that, for the temperature of 500° C. to 750° C. (˜770K to ˜1025K), the process of oxidation is limited by the rate of oxygen mass transfer to the particle surface and, thus, with a rise in temperature within this range, there is little change in the time taken for combustion of the particle. Below 500° C. (˜770K), the rate of heterogeneous oxidation by oxygen is described by the first order reaction of oxygen and zero order reaction in concentration of water with an activation energy of 150 kJ/mol and pre-exponent of 4×10⁷ cm³/(g.s). It was concluded that the rates of gasification and oxidation of coal in SCW/oxygen are high enough for the generation of actuating fluids for vapor-gas power devices with high energetic and ecological efficiency.

In the studies described in the second of the two Vostrikov publications, a coal particle pack was converted using SCW. Coal from the Yakusk coalfield was comminuted and the coal particles were added, together with an anticaking agent, at room temperature to a tubular reactor. The sealed reactor was heated (externally) to 400° C. (˜675K) and distilled water was added to pressurize the reactor to about 30 MPa (300 bar). When the required operating temperature (500-750° C.) was reached, SCW was pumped upwards through the coal layer. The conversion products were collected and analyzed and found to include hydrogen, methane, ethane, benzene, toluene, xylene, carbon monoxide and carbon dioxide.

Vostrikov et al speculate that, for industrial SCW conversion processes, the addition of an oxidant (e.g. air or pure oxygen) into the SCW flow is inevitable for providing an autothermal character to the process. The addition of air or pure oxygen to the SCW flow results in production of carbon dioxide. Vostrikov et al have observed that increasing the concentration of carbon dioxide in the SCW flow has the effect of reducing the concentration of all of the conversion products except carbon monoxide.

The results indicated that, under the conditions studied, SCW conversion is a highly efficient process of coal transformation into supercritical products. The efficiency of the total conversion was observed to be no less that 93.5%. The autothermal character of the process can be provided by direct combustion of some part of the fuel in SCW.

An object of preferred embodiments of the present invention is to improve processes by which coal is converted to valuable products which are gaseous or liquid at atmospheric pressure by a process of conversion in heated supercritical water plus oxygen. Further objects of preferred embodiments of the present invention include increasing the yield of hydrogen, carbon monoxide, and hydrocarbon products; increasing coal conversion efficiency and allowing efficient separation and removal of ash residue from combustion; reducing formation of tar and hard coke within the system and reducing coal agglomeration; designing a reactor system to facilitate the supercritical water/oxygen/coal reactions; and providing an overall design for an SCW/O₂/coal conversion process that increases the production of net shaft power and/or process heat from the system.

### BRIEF SUMMARY OF THE INVENTION

According to a first aspect of the present invention, there is provided a process for producing hydrocarbon compounds from coal, said process comprising:
reacting carbonaceous material with SCW in a first reaction zone at a temperature from at least 850K to produce a first supercritical fluid mixture comprising hydrocarbon compounds;
mixing coal with at least a portion of said first supercritical fluid mixture or a supercritical fluid mixture derived therefrom to form a supercritical fluid reaction mixture at a temperature within a range from the supercritical temperature of water, i.e. about 647K, to about 695K; and
maintaining said supercritical fluid reaction mixture within said temperature range for sufficient time to extract hydrocarbon compounds from said coal and produce a second supercritical fluid mixture comprising said hydrocarbon compounds. The process usually also produces other valuable products such as hydrogen and carbon monoxide.

“Hydrocarbon compounds” are hydrocarbon compounds having a lower molecular weight than the coal feedstock. The hydrocarbon compounds are typically produced in three fractions, i.e. a gas fraction; a liquid hydrocarbon fraction having a density less than water; and a hydrocarbon fraction having a density greater than water. The gas fraction usually comprises C₁-C₄ alkanes such as methane, ethane and propane; and C₂-C₄ alkenes such as ethene and propene. The gas fraction typically also includes hydrogen; carbon monoxide; and carbon dioxide. The liquid hydrocarbon fraction usually comprises a mixture of benzene; toluene; and xylenes (“BTX”). The denser hydrocarbon fraction usually comprises the heavier, e.g. C₈-C₂₀ hydrocarbon fragments.

“Coal” is a fossil fuel in the form of a readily combustible black or brownish-black rock and is composed of primarily carbon, together with assorted other elements including hydrogen, oxygen and sulfur. There are various types of coal (based generally on the content of volatile components) ranging from sub-bituminous coal (or lignite) to bituminous coal and anthracite. Whilst the present invention may be applied to the conversion of any type of coal, it has particular application in the conversion of coal with a high content of volatile components. Particularly suitable coal includes sub-bituminous (or brown) coal or lignite.

“Carbonaceous” material is material that is rich in carbon. Carbonaceous materials usually comprise at least carbon and hydrogen and have a high carbon to hydrogen ratio. Carbonaceous materials include coal; coke; and coal char.

“SCW” is water which is at a temperature and pressure exceeding its critical temperature and critical pressure. The critical temperature of water is the temperature above which water cannot be liquefied by an increase in pressure, i.e. 374° C. (˜647K). The critical pressure of water is the pressure of water at its critical temperature, i.e. 22.1 MPa (221 bar).

According to a second aspect of the present invention, there is provided a reactor system for producing hydrocarbon compounds from coal, said reactor system comprising:
a source of SCW;
a first reaction zone for reacting carbonaceous material with SCW at a temperature of at least 850K to produce a first supercritical fluid mixture comprising hydrocarbon compounds;
a mixing zone for mixing coal with at least a portion of said first supercritical fluid mixture or a supercritical fluid mixture derived therefrom to form a supercritical fluid reaction mixture at a temperature within a range from the supercritical temperature of water to about 695K; and
a second reaction zone for maintaining said supercritical fluid reaction mixture within said temperature range for sufficient time to extract hydrocarbon compounds from said coal and produce a second supercritical fluid mixture comprising hydrocarbon compounds.

### BRIEF DESCRIPTION OF SEVERAL VIEWS OF THE DRAWINGS

FIG. 1 is a flowsheet depicting an embodiment of the present invention; and

FIG. 2 is a flowsheet depicting another embodiment of the present invention.

### DETAILED DESCRIPTION OF THE INVENTION

The process according to the first aspect of the present invention comprises, in a first (or hydrogenation) stage, reacting carbonaceous material with SCW at a temperature from at least 850K to produce a first supercritical fluid mixture comprising hydrocarbon compounds. Coal is mixed with at least a portion of the first supercritical fluid mixture or a supercritical fluid mixture derived therefrom to form a supercritical fluid reaction mixture at a temperature within a range from about 647K to about 695K. In a second (or extraction) stage, the supercritical fluid reaction mixture is maintained within that temperature range for sufficient time to extract hydrocarbon compounds from the coal and produce a second supercritical fluid mixture comprising hydrocarbon compounds. The supercritical fluid reaction mixture is preferably maintained at a constant, or at least substantially constant, temperature in the second stage.

One advantage of the present invention over the prior art is that, whilst a hydrogenation catalyst may be used in the first stage, use of such a catalyst is not necessary and, in preferred embodiments, the reaction of carbonaceous material with SCW is uncatalyzed.

The second supercritical fluid mixture contains hydrocarbon compounds produced by hydrogenation of carbonaceous material with SCW in the first reaction zone and by extraction from coal in the supercritical fluid reaction mixture. In addition, the first supercritical fluid mixture usually also comprises solid particles of ash and, perhaps, depleted carbonaceous material entrained therein. Further, the second supercritical fluid mixture usually also comprises solid particles of depleted carbonaceous material or “char” and, perhaps, ash entrained therein.

The temperature within the first reaction zone may be from about 870K to about 1075K, preferably from about 920K to about 1025K, and typically from about 970K to about 1025K. In the extraction stage, the supercritical fluid reaction mixture is usually maintained at a temperature from about 655K to about 685K and, preferably, from about 660K to about 675K.

Provided that the operating pressure of the process is more than the supercritical pressure of water, i.e. about 221 bar, then the operating pressure is not usually critical to the process. In preferred embodiments, the operating pressure is usually from about the supercritical pressure of water (about 221 bar) to about 400 bar, preferably from about 250 bar to about 350 bar, e.g. about 300 bar.

Heat required to react said carbonaceous material with the SCW is usually provided internally. For example, the SCW usually comprises oxygen to combust a portion of the carbonaceous material thereby providing a portion of the heat. The oxygen is typically present in the SCW in an amount sufficient to raise the temperature in the first reaction zone to within a range from about 870K to about 1075K.

An oxygen-containing gas such as air may be added to the SCW to combust the portion of carbonaceous material. However, the oxygen-containing gas typically contains at least 50% and, preferably, at least 90%, oxygen (with the remainder being inert gas(es) such as nitrogen and/or argon). The use of an oxygen-containing gas containing at least 95% oxygen is preferred.

The oxygen-containing gas may come from any suitable location. For example, oxygen gas may be stored in a pressurized storage vessel and fed, with compression and/or pre-heating as required, to the first reaction zone. Oxygen may be stored in a cryogenic storage tank as liquid oxygen; pumped in a liquid oxygen (LOX) pump to the required pressure and heated in a suitable heat exchanger to produce oxygen gas at the required temperature and pressure. However, in preferred embodiments, oxygen is produced on site in a cryogenic air distillation system, preferably operating a pumped LOX cycle. The LOX may taken from the cryogenic air separation system at the required pressure and heated to produce oxygen gas at the required temperature which is then fed to the reactor system.

A further portion of heat is usually provided externally. For example, the SCW may be pre-heated to less than about 1020K. Additionally, oxygen may be pre-heated, e.g. by indirect heat exchange against SCW, to produce pre-heated oxygen and at least a portion of the pre-heated oxygen may be combined with SCW before reacting with the carbonaceous material. The oxygen may be pre-heated to a temperature from about 550K to about 700K and, preferably, from about 600K to about 650K, e.g. about 625K.

The second supercritical fluid mixture usually comprises solid particles of carbonaceous char and ash. The solid particles are usually separated from the second supercritical fluid mixture to form separated solid particles and particle-free, second supercritical fluid mixture. The separated char is usually in a finely reduced form. In some preferred embodiments, at least a portion of the separated char is used as feed to a conventional coal fired power station or to a gasifier. In other preferred embodiments, at least a portion of the separated char is used as at least a portion of the carbonaceous material fed to the first reaction zone.

Pressurized water may be heated by indirect heat exchange against the particle-free, second supercritical fluid mixture to produce the SCW and an aqueous fluid mixture comprising the hydrocarbon compounds. The SCW may then be divided into a first portion and a second portion. Oxygen may be pre-heated by indirect heat exchange against the first portion of SCW to form pre-heated oxygen and cooled water. At least a portion of the pre-heated oxygen may be combined with the second portion of SCW to form a supercritical water/oxygen (SCW/O₂) mixture before reaction with the carbonaceous material. In these embodiments, at least a portion of the cooled water is usually recycled to form SCW, together with fresh make up water and water recycled from downstream product separation units (see below).

The pressure of the aqueous fluid (i.e. “cooled” particle-free, second fluid mixture) may be reduced, usually over a suitable pressure reducing device such as a valve, thereby forming a multi-phase fluid mixture which may be separated into a fuel gas fraction; a liquid hydrocarbon fraction; a heavy hydrocarbon oil fraction; and a water fraction. The pressure of the multi-phase fluid mixture is, preferably, from about 10 bar to about 60 bar. In these embodiments, at least a portion of the water fraction is preferably recycled to produce SCW. At least a portion of the heavy hydrocarbon oil fraction may be recycled to the first reaction zone after suitable pressurization.

Coal is preferably pulverized to form pulverized coal which is then used to form a coal water slurry (CWS). Any appropriate size of the pulverized coal particles may be used. However, coal particles having an average diameter of no more than 2 mm, e.g. from about 0.1 mm to about 1.5 mm, are preferred. The slurry usually comprises from about 40% to 60%, preferably 40% to 45%, solids in water.

The slurry is usually compressed in a suitable fluid pump to the operating pressure of the process, usually from about 221 bar to about 400 bar. The pressurized CWS can be preheated but preferably not to a temperature over 570K to avoid agglomeration of the slurry to a paste-like form. The mixing of the preheated CWS and the first supercritical fluid mixture (or the supercritical fluid mixture derived therefrom) to produce the second supercritical reaction mixture results in a significant decrease in the density of the fluid mixture and this effect should be accommodated by a suitable design of mixing zone in the reactor system (as discussed below).

In some embodiments, the pressurized CWS is divided into a first portion and a second portion. The first portion may be used as the carbonaceous material and the second portion may be mixed with the first supercritical fluid mixture or the mixture derived therefrom.

Solid ash particles are usually separated from the first supercritical fluid mixture to form separated ash and particle-free, first supercritical fluid mixture which is then mixed with the coal feed.

Heat to react the carbonaceous material with SCW may be provided externally. In these embodiments, a portion of the heat may be provided by pre-heating the SCW to at least about 1020K.

The process may be carried out in a batch reactor system. However, in preferred embodiments, the process is carried out in a continuous flow reactor system. In these embodiments, the process may comprise operating the reactor system discontinuously, e.g. in cycle comprising an “on-line” phase in which carbonaceous material and coal is converted into hydrocarbon compounds, and an “off-line” phase in which solid carbonaceous material deposited within the reactor system is removed by combustion in a flow of, usually heated, SCW and oxygen.

The reactor system typically operates in the “on-line” phase until the extent of the deposition of solid carbonaceous material is such that the reactor system needs to be cleaned. The period of the “on-line” phase is highly variable and depends on several factors such as the composition of the coal feedstock and the material from which the internal components of the reactor (e.g. those components in contact with the fluid reaction mixtures) are made. The period may be from as little as about 30 minutes to as much as about 1 week or more.

The reactor system typically operates in the “off-line” phase until the reactor system has been cleaned of the deposits of solid carbonaceous material. The period of the “off-line” phase is highly variable and depends on several factors such as the extent of the deposition and the material of the internal components. However, the “off-line” phase usually lasts from about 5 minutes to about 1 hour.

Limestone (CaCO₃), sodium carbonate (Na₂CO₃), or sodium hydroxide (NaOH) or mixtures thereof may be added to the feedstock to facilitate desulfurization of the coal.

The reactor system according to the second aspect of the present invention comprises a source of SCW; a first reaction zone for reacting carbonaceous material with SCW at a temperature from at least 850K to produce a first supercritical fluid mixture comprising hydrocarbon compounds; a mixing zone for mixing coal with at least a portion of the first supercritical fluid mixture or a supercritical fluid mixture derived therefrom to form a supercritical fluid reaction mixture at a temperature within the range from the supercritical temperature of water to about 695K; and a second reaction zone for maintaining the supercritical fluid reaction mixture within that temperature range for sufficient time to extract hydrocarbon compounds from the coal and produce a second supercritical fluid mixture comprising hydrocarbon compounds. Conduits are used to provide suitable fluid communication between the various parts of the reactor system where appropriate.

The reactor system usually comprises a first solid particle separator for separating ash particles from the first supercritical fluid mixture to produce separated ash particles and particle-free, first supercritical fluid mixture.

The reactor system usually comprises a second solid particle separator for separating char particles from the second supercritical fluid mixture to produce separated char particles and particle-free, second supercritical fluid mixture which is usually a homogenous fluid mixture of water and the conversion products. In some embodiments, the reactor system also comprises a conduit for feeding separated char particles from the second solid particle separator to the first reaction zone. The conduit usually comprises a pump, such as an Archimedean screw pump, to drive the solid particles along the conduit.

The or each solid particle separator is usually a solid/liquid separation device such as a hydrocyclone separator. The first solid particle separator preferably comprises a lock hopper for removal solid ash particles.

The reactor system is usually part of a plant that further comprises energy conversion and product recovery units. The particle-free, second supercritical fluid mixture containing water and conversion products is usually fed to the energy conversion unit comprising a heat exchanger where heat is recovered by indirect heat exchange with pressurized water to produce SCW and a cooled multi-phase fluid containing water; fuel gas; and liquid hydrocarbon components. The temperature of the particle-free, supercritical fluid mixture is usually reduced in the heat exchanger to about 5° C. to about 65° C., e.g. about 20° C. to about 55° C. or about 35° C. to about 50° C. After heat exchange, the pressure is also usually reduced, e.g. to between from about 10 bar to 60 bar, to allow the liquid and vapor phases to separate, producing the multi-phase fluid.

The reactor system may also comprise:
a second heat exchanger for pre-heating oxygen-containing gas by indirect heat exchange against SCW to produce pre-heated oxygen-containing gas and cooled water; and
a conduit for feeding pre-heated oxygen-containing gas to said first reaction zone.

Suitable heat exchangers include a diffusion bonded multi-channel block such as those manufactured by Heatric Ltd (Poole, Dorset, UK).

The multi-phase fluid is usually fed to the product recovery unit which usually comprises a phase separation system where it is separated into a fuel gas stream; a water stream; and at least one liquid hydrocarbon stream. The water stream is usually recycled, with fresh make up water, to produce SCW. A stream of heavy hydrocarbon oil is usually produced, at least part of which may be recycled to the first reaction zone.

The first or second reaction zone preferably includes a device for agitating or creating turbulence to increase mass transfer rates between the particles of coal or other carbonaceous material and the SCW. Any suitable devices may be used including static mixers. However, in preferred embodiments, the first and/or second reaction zone usually comprises at least one internal concentric flow separation shell to increase fluid velocity for a given residence time. The number of concentric shells is usually from 1 to 5. For example, the first reaction zone preferably has three concentric shells providing a “four-pass” arrangement and the second reaction zone preferably has one concentric shell providing a “two-pass” arrangement. Preferably, the cross-sectional area of each concentric passage is the same as each other concentric passage in a given reactor. The “coldest” fluid is preferably passed through the outermost passage to reduce the temperature of the reactor wall as far as possible.

The internal components of the reactor system are usually made from a metal selected from the group consisting of titanium and copper and alloys thereof.

The following is a further description of preferred embodiments of the first and second aspects of the present invention.

Regarding the first reaction zone, depleted coal (or “char”) particles or fresh CWS feed is usually mixed, and reacted, with a homogenous fluid of pre-heated supercritical water and oxygen (SCW/O₂) to produce the first supercritical fluid mixture. The SCW/O₂ fluid reacts with at least a portion of the coal or char feed to the first reaction zone to provide all the heat requirements of the reactor and to give an outlet temperature of above 870K. Part of the coal or char organic mass (COM) is converted in a complete oxidation reaction to carbon dioxide and water. The remaining COM may also react directly with water molecules to produce hydrogenated coal conversion products. The temperature at which this direct conversion reaction takes place is preferably above 870K.

Regarding the second reaction zone, at least a portion of the CWS is usually introduced into the second reaction zone in a manner so as to provide rapid heating of the CWS and result in rapid de-volatilization of the coal particles. One suitable way to introduce the CWS into the second reaction zone is via a nozzle which results in the CWS being injected in the form of fine droplets which assists with ejection and extraction of a significant portion of the COM depending on the rank or type of coal used. The total COM of the coal feed is defined as the total mass of the coal feed less the mass of the ash and moisture content of the coal feed. Such a process is known as low temperature dynamic conversion (LTDC).

Depending on the type of coal used, the proportion of the COM removed as LTDC products is typically in the range 40 wt % to 60 wt %. For example, for a typical sub-bituminous coal, the LTDC fraction may be about 45% of the total COM of the coal feed.

The CWS is usually injected into the second reaction zone. The condition of CWS injection is important, since the coal has a very strong tendency to coke under conditions of SCW pressures and temperatures of about 695K to about 725K. The temperature for this stage is kept below 695K to prevent coal caking. This caking of coal may be aggravated by the metal surfaces which contact the coal in the injection tubes. In this connection, the Inventor observed that 9 mm stainless steel injection tubes were blocked promptly in an experimental reactor and concluded that stainless steel is not suitable for use with CWS, probably due to an interaction of carbon in CWS with carbon in the stainless steel. The Inventor found that the use of a metal selected from titanium; copper; or an alloy thereof, for the injection tubes significantly reduces aggravation of caking and, thus, is preferred.

The injection of “cold” CWS which is above supercritical pressure of water necessitates the heating of the CWS to above the supercritical temperature of water (˜647K) but below the temperature at which coal caking occurs, e.g. about 695K. The water density will decrease significantly as the temperature rises through the critical region leading to a volume increase in the CWS and a pressure pulse if the CWS is within a tubular injection inlet. Therefore, the mixing zone should be designed having a change in cross-sectional area to allow for this reduction in density and avoid the pressure pulse. This expansion preferably occurs into a water medium having a flow rate and temperature that are sufficient to raise the temperature of the feed CWS to the preferred temperature range of about 660K to about 675K.

Whilst the CWS is usually introduced into the second reaction zone at a temperature below about 370K, the CWS may be pre-heated to above this temperature. However, the Inventor has observed that, if a CWS containing brown coal is heated up to the supercritical temperature of water (˜647K), the coal particles swell and that, at this temperature, the CWS converts to a paste-like form. Accordingly, whilst the CWS may be pre-heated prior to introduction into the second reaction zone, pre-heated CWS should not exceed about 570K and, preferably, is in the range from about 520K to about 570K. The actual behavior of the CWS will depend on the properties of the coal used.

In the relevant embodiments of the invention as considered as a whole, the oxidation reaction in the first reaction zone usually provides the heat required to maintain heat balance around the reactor system. The heat produced in the oxidation reaction usually provides the heat required to react coal or char COM directly with water in the first reaction zone. The heat produced is also usually sufficient to provide the, preferably rapid, direct contact heating of the CWS in the second reaction zone.

The coal conversion reactor system has a first reaction zone, a mixing zone and a second reaction zone but is usually a dual reactor unit in which the first reaction zone is within a first reactor and the mixing and second reaction zones are within a second reactor designed to facilitate LTDC of coal particles in the CWS. The second stage of the process is accomplished, either partially or totally, by direct contact of coal particles with water flowing from the first reaction zone.

The first reactor usually operates in the temperature range from about 675K at the SCW/O₂ inlet point to between from about 870K to about 1075K and, preferably, between from about 970K to about 1025K at the first supercritical fluid mixture outlet point. The second reactor usually operates at a temperature of below about 695K and, preferably, in the range from about 650K to about 685K.

The first or second reactor is, preferably, a tubular device with a high length to diameter ratio. Such an aspect ratio reduces the capital cost of the reactor as the reactor may have a thinner reactor wall. In addition, such an aspect ratio not only increases the length of the internal flow path and but also the fluid velocities, thereby increasing fluid turbulence and promoting good mixing. A suitable aspect ratio for the first reactor may be from about 10:1 to about 50:1, e.g. from about 30:1 to 40:1. A suitable aspect ratio for the second reactor may be from about 20:1 to about 80:1, e.g. from about 40:1 to about 60:1.

The dimensions of suitable first and second reactors depend on a number of factors including the nature of the reactions occurring therein. The first reactor may have a length from about 5 m to about 60 m, e.g. from about 30 m to about 50 m, and an internal diameter from about 0.1 m to about 4 m, e.g. from about 0.5 m to about 3 m. A suitable second reactor may have a length from about 5 m to about 50 m, e.g. about 20 m to about 40 m, and an internal diameter from about 0.05 m to about 2.5 m, e.g. about 0.1 m to about 1 m. For example, based on a duty of one million tonne/year of coal feed, a suitable first reactor may have a length from about 30 m to about 50 m, and an internal diameter from about 2 m to about 3 m. A suitable second reactor may have a length from about 20 m to about 40 m, and an internal diameter from about 0.75 m to about 0.5 m.

In preferred reactors, the flow of coal/char and SCW, with or without oxygen, is co-current. With co-current flow reactors, the fluid velocity through the reactor is usually sufficiently high to ensure that solid particles remain entrained in the fluid flow and, thus, tubular reactors such as pipe reactors are preferred.

As mentioned above, co-current tubular reactors will usually comprise two or more internal concentric flow separation shells in an overall reactor shell of suitable length. The use of the concentric shells increases the length of the first and second reaction zones in proportion to the length of the reactor and the number of concentric shells.

Regarding the final design of preferred reactors, the Inventor observed that, at 925K, the time required for oxidation of 2 mm coal particles at very low temperatures for relative velocity of coal particle and water of 1 mm/s, is about 150 s. The density of water at 1025K is very low, i.e. about 69 kg/m³ which means that the volume of the first reactor is preferably high compared to the second reactor even though less than about 10% of the COM is usually gasified in the second reactor. The Inventor proposes to greatly reduce the required residence time in the first reactor but, in preferred embodiments, to maintain the required heat release from combustion of the COM feed by only using partial combustion of each coal particle. The Inventor observed that, for example, a 50 s residence time results in about 50% combustion of a 2 mm coal particle at 925K. Thus, if residence time in the first reactor is from about 50 s to about 100 s, it is possible to design a reasonable size reactor having a minimum diameter which is an important consideration when designing reactors to work at operating pressures of up to, for example, 400 bar.

In embodiments where the first reaction zone is used for complete conversion of the COM in the coal or coal char feed, the conditions in the reactor are usually chosen such that the carbon content of the ash produced in the first reaction zone is below about 2 wt % and, preferably, below about 1 wt %. The ash is usually removed from the first supercritical fluid mixture before feeding at least a portion of the ash-free, first supercritical fluid mixture to the mixing zone.

SCW reacts with coal at temperatures above about 850K and, preferably, above about 870K, to produce carbon dioxide and hydrogen. At these temperatures, reactions also occur between hydrogen and coal to form methane and higher molecular weight hydrocarbons. A summary of possible reactions is as follows:
(1) Coal oxidation by free oxygen (exothermic)

CₓH_{y}O_{z}+[i +½(j+k)]O₂→iCO₂+jCO+kH₂O+Cₓ₋ᵢ₋ⱼH_{y-2k}O_{z}
(2) Oxidation using oxygen bonded in coal (exothermic)

CₓH_{y}O_{z}→iCO₂+jCO+kH₂O+Cₓ₋ᵢ₋ⱼH_{y-2k}O_{z}
(3) Reaction of water with coal (endothermic)

CₓH_{y}O_{z}+½(n+2)H₂O→iCO₂+jCO+H₂+CₘHₙ+Cₓ₋ᵢ₋ⱼ₋ₘH_{y}O_{z-2i-j+0.5n+1}

In addition, the following exothermic shift reaction will usually occur:

CO+H₂O ⇄CO₂+H₂

The extent of these reactions usually depends on the kinetics and catalytic effects caused by components in the coal ash.

The heat balance around the reactor system usually requires an input of heat either as sensible heat in the SCW feed to the reactor system, or as a release of heat caused by oxidation of combustible components with oxygen or by a combination of both. Thus, in some embodiments, SCW feed to the first reaction zone is pre-heated using external heating means to temperature of about 1020K or higher. In other embodiments, pre-heated oxygen is supplied and combustion in the first reaction zone produces heat and carbon dioxide and water.

The heat input must balance heat loss from the reactor system; the endothermic heat of the water/coal reactions and the LTDC reaction; and the difference in total sensible heat content between total reactor system feeds and total reactor system products. It is preferable to operate with SCW/O₂ fluid rather than SCW at 1020K and with a pre-heat to above the supercritical temperature of water. The reaction of free oxygen with coal is usually very rapid and consumes COM in the coal or char feed while raising the water temperature to 970K to 1025K in usually less than 1 minute, e.g. less than 10 seconds.

Depending on the rank, quantity and nature of the COM in the coal which can be released by LTDC treatment, one option for the use of this process is to pre-treat coal feed to a conventional coal fired power station to remove valuable gaseous and liquid products including hydrogen; methane; carbon monoxide; ethane; benzene; toluene; and xylene, together with a heavy oil product containing higher molecular weight hydrocarbon compounds and oxygenates. The residual coal char is in a finely reduced form which could be used as feed to the existing pulverized coal fired boilers. Another option is to use the residual coal char as feed to a higher pressure, high temperature entrained flow oxygen based gasifier such as the gasifiers used in the GE/Texaco, Shell or Conoco Phillips processes which are extensively described in open literature. One advantage of this pretreatment option is that a significant portion of the sulfur present in the coal is removed in the LTDC products or is chemically combined in the ash fraction. The proportion depends on the nature of the coal used.

One advantage of this gasifier feed option is that the sensible heat content of the supercritical water and coal char in the gasifier feed may be retained and no pressurization of the slurry, e.g. in a slurry pump, is necessary since the coal char product is at a pressure above 221 bar. A further advantage is that a slurry having an appropriate coal char to water ratio can be produced directly from the char separator by eliminating the maximum amount of water while ensuring that the slurry can still flow evenly into the high pressure gasifier vessel. Such an arrangement is likely to increase the overall thermal efficiency. With modifications to the burners allowing direct coal slurry injection, it should be possible to also retain the sensible heat in the pulverized coal fired boiler application with a further possible advantage of reduction in NOₓ formation.

Processes according to the present invention are particularly advantageous since the contact time of coal with SCW to accomplish the removal of LTDC products from the coal particles is short, generally less than 5 minutes and usually less than 30 seconds, reducing the required volume of the second reaction zone. The residence time in the second reaction zone is typically in the range from about 1 second to about 30 seconds and, preferably, in the range from about 3 seconds to about 20 seconds. The residence time in the first reaction zone is generally less than 5 minutes and is typically in the range 20 seconds to 150 seconds and preferably in the range 30 seconds to 100 seconds

In preferred embodiments, only sufficient supercritical high temperature water is mixed with pre-heated CWS in the mixing zone to reach the required temperature for the LTDC reactions to occur efficiently in the second reaction zone. If there is an excess of supercritical fluid from the first reaction zone, the excess fluid usually bypasses the second reaction zone. If there is a deficit of supercritical fluid from the first reaction zone, SCW is usually pre-heated externally and added to the supercritical fluid from the first reaction zone for use in the second reaction zone.

A usual feature of the first reaction zone is the limitation of the degree of saturation of the SCW to about 20 wt % as reported by Vostrikov et al (see above). There is usually also a limitation in the reaction rate per gram of SCW which is a function of the degree of conversion of the coal or coal char. These two factors usually determine the ratio of SCW to coal or coal char feed in the first reaction zone and the residence time, and hence reactor volume required for a given plant capacity.

The final conditions (e.g. temperatures, pressures, flow rates, etc.) for a given process may be readily calculated on the basis of the disclosure herein in combination with the common general knowledge in the art.

As mentioned above, the process of the present invention may be applied in the pre-treatment of coal to produce conversion products and coal char for use elsewhere (for example in a conventional coal fired power station or gasifier) or for the complete conversion of coal. The following is a detailed description of an embodiment of each of these applications.

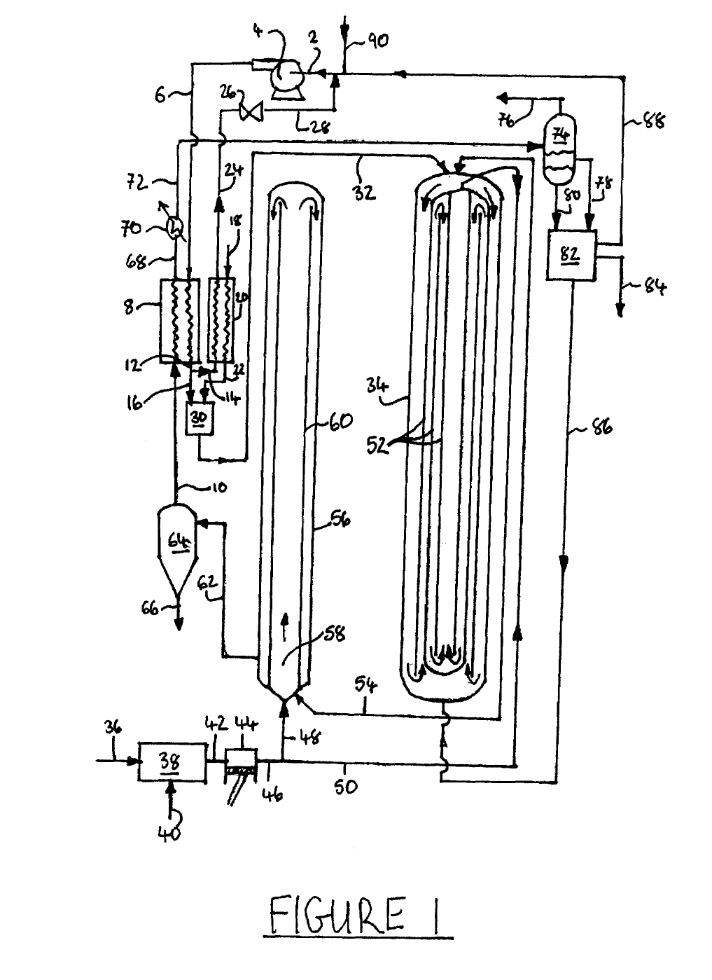

Referring to FIG. 1, a stream 2 of feed water is pumped in a centrifugal multi-stage water pump 4 to the operating pressure of the process which, in this embodiment is about 300 bar, to produce a stream 6 of pressurized water. Pressurized water stream 6 is fed to a heat exchanger 8 where it is heated by indirect heat exchange against a stream 10 of particle-free, second supercritical fluid mixture produced downstream (see below) to produce a stream 12 of SCW at a temperature of about 655K. SCW stream 12 is divided into two sub-streams, stream 14 and stream 16.

A stream 18 of pure (i.e. at least 95%) oxygen gas at 300 bar and ambient temperature, e.g. about 300K, is fed to a heat exchanger 20 where it is heated by indirect heat exchange against SCW stream 14 to produce a stream 22 of pre-heated oxygen gas at a temperature of about 623K and a stream 24 of cooled water. The pressure of the cooled water stream 24 is reduced over a pressure reduction device 26 to produce a stream 28 of reduced pressure water which is then recycled to form part of feed water stream 2. The stream 22 of pre-heated oxygen gas is combined with the stream 16 of SCW in a mixing vessel 30 to produce a stream 32 of a supercritical homogenous single phase mixture of SCW and oxygen (SCW/O₂) which is fed to a first reactor 34.

Coal is fed via line 36 to a coal grinding system 38 where it is pulverized to a particle size from about 0.1 mm to 1.5 mm and mixed with a stream 40 of water at about 1 bar and about 355K to produce a stream 42 of CWS containing about 50 wt % coal. CWS stream 42 is pumped in a high pressure pump 44 to produce a stream 46 of pressurized CWS at the operating pressure of the process, about 300 bar. CWS stream 46 is divided into two sub-streams, stream 48 and stream 50. CWS stream 50 is fed to the first reactor 34 where it is mixed with the SCW/O₂ from stream 32 to produce a coal/SCW/O₂ mixture under supercritical conditions.

The first reactor 34 is a tubular reactor having a high length to diameter ratio and containing a set 52 of three internal concentric flow separation shells defining a first reaction zone consisting of four concentric passages, each passage having the same cross-sectional area as the other passages. The coal/SCW/O₂ mixture, having an initial fluid velocity of about 0.35 m/s, passes through the passages covering a total distance of about 150 m and reaching a final fluid velocity at the end of the fourth passage of about 3.05 m/s. The velocity of the fluid entering the second passage of the reactor is sufficiently high to entrain all of the coal particles. Virtually all of the oxygen is consumed in the oxidation reactions described above thereby raising the temperature of the fluid reaction mixture as it passes through the reactor and enabling direct hydrogenation of the coal particles with water thereby producing a first supercritical fluid mixture comprising hydrocarbon compounds. The first supercritical fluid also contains carbon dioxide and coal residue. The “coldest” fluid passes through the outermost concentric passage so as to limit the temperature of the outer wall of the reactor 34. The residence time in the first reactor is about 90 seconds.

A stream 54 of the first supercritical reaction fluid is removed from the first reactor 34 and fed to a second reactor 56 where it is mixed with CWS stream 48. The temperature (about 1025K) and flow rate of the first supercritical reaction fluid produced by the first reactor 34 are selected to provide, after mixing with the CWS, the desired temperature and flow rate of the mixture. The second reactor 56 has a mixing zone 58 and one internal concentric flow separation shell 60 defining a second reaction zone consisting of two concentric passages, each passage having the same cross-sectional area as the other passage. The CWS and the first supercritical reaction fluid are mixed to form a fluid reaction mixture at a temperature of about 675K. The fluid reaction mixture passes through the two passages defined by the concentric shell 60 while maintained at that temperature thereby enabling the LTDC reactions to take place to produce a second supercritical fluid mixture comprising hydrocarbon compounds and entrained coal char particles. As the temperature is at least substantially constant in the second reactor, the flow velocity is also at least substantially constant and, in this case, about 2.4 m/s in each pass.

A stream 62 of second supercritical fluid mixture is removed from the second reactor 56 and fed to a hydrocyclone solids separator 64 where the entrained coal char is removed from the mixture to produce a stream 66 of separated coal char and the stream 10 of particle-free, second supercritical fluid mixture at about 675K.

The separated char may then be used in a conventional coal fired power station to produce power or in a gasifier to produce syngas which in turn may be used to generate power and/or be converted into further hydrocarbon compounds.

The single phase stream 10 of particle-free, supercritical fluid mixture is cooled in heat exchanger 8 to produce a cooled stream 68 which is further cooled in a water cooler 70 and reduced in pressure to 40 bar to produce a multi-phase stream 72 which is fed to a phase separator 74 where it is separated into a gas phase (consisting of hydrogen, carbon monoxide, methane, ethane and carbon dioxide) removed as stream 76 and aqueous and organic liquid phases (containing water, BTX and heavy hydrocarbon oils) removed as streams 78 and 80 and which undergo further treatment in product separator 82 to produce a stream 84 of valuable hydrocarbon compounds (BTX); a stream 86 of heavy hydrocarbon oil which is recycled to the first reactor 34 to be converted into hydrocarbon compounds; and a stream 88 of water which is combined with a stream 90 of fresh make up water and recycled as part of the feed water stream 2. Any organic material present in water stream 88 will be hydrogenated by reaction with water in the first reactor 34.

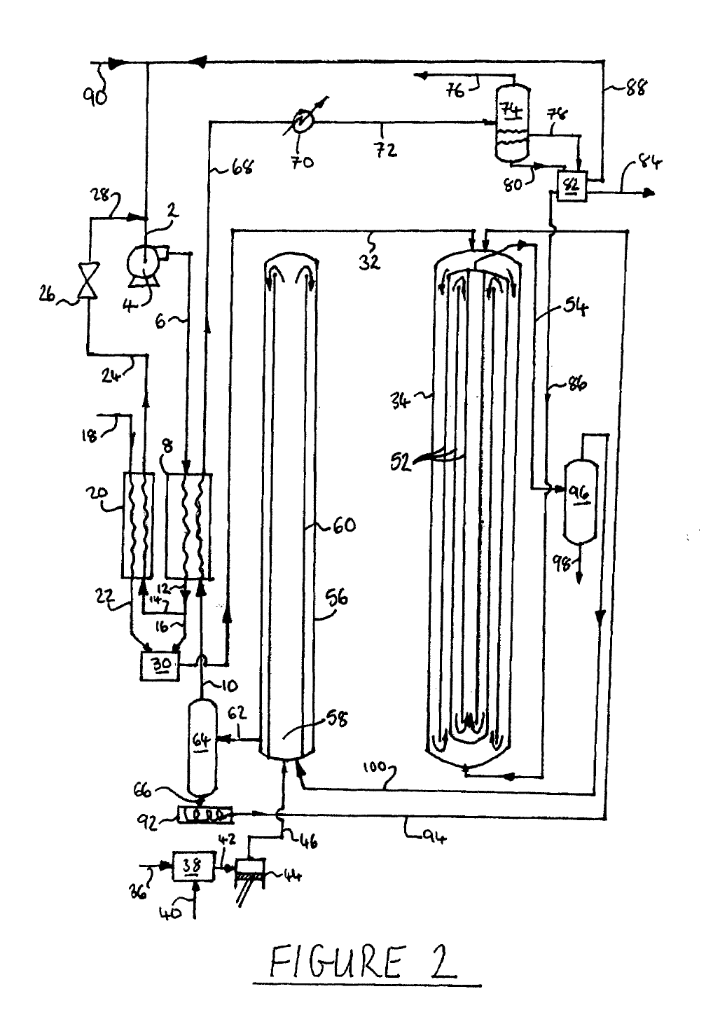

The process depicted in FIG. 2 has many features and conditions in common with the process depicted in FIG. 1. The same reference numerals have been used to denote the features common to both processes. The following is a description of only the features and conditions that distinguish the process of FIG. 2 over the process of FIG. 1.

Referring to FIG. 2, stream 46 of CWS is not divided into two sub-streams but is, instead, fed entirely to the second reactor 56 to undergo the LTDC reactions described above. In addition, rather than using the separated char elsewhere, stream 66 of separated char is pumped using an Archimedean screw pump 92 and fed as stream 94 to the first reactor 34. The operating pressure of the first reactor 34 is slightly higher, e.g. about 2 bar higher, than that of the second reactor 56. The stream 54 of the first supercritical fluid mixture leaving the first reactor 34 is fed to a hydrocyclone ash separator 96 where ash is separated as stream 98 producing a stream 100 of particle-free, first supercritical fluid mixture which is fed to the second reactor 56.

The LTDC products are formed in the second reactor when the cold CWS expands into the ash-free, first supercritical fluid mixture produced in the first reactor. The residence time in the first reactor is sufficient to ensure complete conversion of the coal char produced in the second reactor to conversion products leaving a low carbon content ash. The contacting of the CWS feed at a temperature of about 355K to about 375K with the effluent from the first reactor results in a mixed temperature of about 675K.

The first reactor has sufficient reaction time required for the conversion of char to reaction products by reaction with water at 1025K liberating hydrogen which hydrogenates and converts the COM to low molecular weight products with higher hydrogen to carbon ratios than the coal feed. The heat required in the first reactor for conversion of COM in the char to coal conversion products by reaction with water plus the heat to provide the reactor effluent at about 1025K is produced by complete oxidation of part of the char COM to carbon dioxide and hydrogen using oxygen in the SCW feed.

In the first reactor 34, the SCW/O₂ mixture from stream 32 reacts with the coal char from the second reactor 56 to produce the first supercritical fluid mixture. The quantities of water and oxygen correspond to conditions required to achieve complete coal conversion. For example, for the conversion of brown coal (containing 75 wt % COM) at a given feed flow rate of 10⁶ tonne/year (or 31.7 kg/sec) and where 45% COM is converted by LTDC, the conditions and design parameters are as follows:

a coal char flow rate to first reactor 34 of 21 kg/s (with COM feed flow rate of 13.08 kg/s);

first reactor 34 will have limit of 20% conversion products in the 1025K effluent based on the water feed;

water flow is 65.4 kg/s;

average fluid density in exit fluid stream 100 from the first reactor 34 is about 0.07 kg/l at 1025K and 300 bar;

average reaction rate (based on the second Vostrikov et al reference discussed above) of about 3.5 mg_{COM}/g_{water}/s;

coal char COM feed to first reactor 34 is partially consumed in reactions with oxygen feed to provide the heat required for COM conversion by hydrogenation plus heat for 1025K exit temperature;

COM in char burned to carbon dioxide and water at a rate of 5.29 kg/s;

COM in char converted to valuable conversion products at a rate of 7.79 kg/s;

char oxidation is very rapid;

char conversion rate (based on a water flow of 65.4 kg/s) is 228.9 g/s; and

char residence time in the first reactor 34 is calculated to require 34 seconds.

In this example, the first reactor 34 has been specified with a reactor volume of 50 m³ an internal diameter of 1.25 m and each concentric passage is 42 m long and is designed to accommodate a residence time of about 50 seconds. The second reactor 56 has an internal diameter of about 1.0 m, a length of 30 m and the fluid velocity in each concentric passage is 0.75 m/s.

### EXAMPLE

Studies have been carried out in a pilot scale reactor system to determine the proportion of COM removed from coal during LTDC with SCW.

A 50 wt % slurry of Russian brown coal (grade B2) in water was prepared from 513.3 g coal (dry basis) containing 461.1 g of COM and 52 g coal ash. The empirical formula of the COM in the coal was CH_{0.825}O_{0.21}N_{0.009}. About 25 wt % of the coal particles in the slurry had an average diameter from about 40 μm to about 50 μm and about 75 wt % of the particles had an average diameter from about 200 μm to about 315 μm. The slurry also contained about 0.75 wt % NaOH. All amounts are based on the final weight of the slurry. The slurry at a temperature of 300K was introduced into a reactor at a temperature of 665K and at a pressure of 300 bar using a positive displacement pump. The slurry was exposed to SCW for no more than 15 s. The product mixture was then quenched, allowed to cool, de-pressurized and then analyzed. The total organic products were found to be:
a gas fraction (containing methane, ethane, carbon dioxide, hydrogen and carbon monoxide, benzene, toluene);
a water fraction comprising organic material extracted from the water phase; and
a heavy oil fraction obtained by evaporation of the water fraction at about 335K to remove all traces of volatile components and water.

The remaining coal char weighed 336 g. The LTDC released weighed 185.0 g which is 40.1% of the total coal COM. The empirical formula of LTDC products was CH_{0.99}O_{0.68}.

In subsequent tests, the depleted coal char passed from the first LTDC reactor to a second reactor where the coal was allowed to accumulate in the base of the reactor. The resultant coal char bed was simultaneously subjected to an upward flow of SCW/O₂ which provided a temperature at the top of the coal bed of between 1019K and 1040K. In this test, all LTDC products were passed with the coal char into the second reactor and the total resulting products removed at the temperature from 1019K to 1040K.

The results indicated that complete char conversion could be obtained leaving a finely divided ash with zero detectable carbon content. The results also indicated that, in a continuous flow reactor system with recycle of all water-soluble and heavy components to the first stage reactor system, complete conversion was possible of the total COM in the coal to conversion products (i.e. hydrogen, carbon monoxide, carbon dioxide, ethane, benzene, toluene and xylene).

The process of the present invention utilizes the unique properties of SCW, namely high, almost unlimited, solubility for organic substances and non-polar gases, particularly oxygen; very low solubility for salts and acids; high diffusivity compared to the liquid state; low viscosity and high reactivity for free radical reactions. The conversion of coal in SCW leads to the efficient extraction of organic material; separation of the coal mineral component as ash; and minimizes tar formation. In addition, the low temperatures involved (relative to conventional gasification or coal combustion temperatures) hinder the formation of SOₓ and NOₓ. Further, depending on the ash composition, a significant proportion of the sulfur and virtually all the mercury will be removed in the ash.

It will be appreciated that the invention is not restricted to the details described above with reference to the preferred embodiments but that numerous modifications and variations can be made without departing from the spirit or scope of the invention as defined in the following claims.

1. A process for producing hydrocarbon compounds from coal, said process comprising:
reacting carbonaceous material with supercritical water (“SCW”) in a first reaction zone at a temperature from at least 850K to produce a first supercritical fluid mixture comprising hydrocarbon compounds;
mixing coal with at least a portion of said first supercritical fluid mixture or a supercritical fluid mixture derived therefrom to form a supercritical fluid reaction mixture at a temperature within a range from the supercritical temperature of water to about 695K; and
maintaining said supercritical fluid reaction mixture within said temperature range for sufficient time to extract hydrocarbon compounds from said coal to provide a second supercritical fluid mixture comprising hydrocarbon compounds.

2. The process according to claim 1 wherein the temperature in said first reaction zone is from about 870K to about 1075K.

3. The process according to claim 1 wherein char is produced as a by product of said extraction of coal, said process comprising using at least a portion of said char as at least a portion of said carbonaceous material.

4. The process according to claim 1 wherein said SCW comprises oxygen to combust a portion of said carbonaceous material to provide at least a portion of the heat required to react said carbonaceous material with said SCW.

5. The process according to claim 4 wherein oxygen is present in said SCW in an amount sufficient to raise the temperature in the first reaction zone to within a range from about 870K to about 1075K.

6. The process according to claim 4 wherein said SCW is pre-heated to less than about 1020K.

7. The process according to claim 4 comprising:
pre-heating oxygen to produce pre-heated oxygen; and
combining at least a portion of said pre-heated oxygen with SCW before reacting with said carbonaceous material in said first reaction zone.

8. The process according to claim 7 wherein said oxygen is pre-heated to between from about 550K to about 700K.

9. The process according to claim 1 wherein said second supercritical fluid mixture comprises solid particles of char entrained therein, said process comprising:
separating said char particles from said second supercritical fluid mixture to form separated char particles and particle-free, second supercritical fluid mixture; and
heating pressurized water by indirect heat exchange against said particle-free, second supercritical fluid mixture to produce said SCW and an aqueous fluid mixture comprising said hydrocarbon compounds.

10. The process according to claim 9 comprising:
dividing said SCW is into a first portion and a second portion;
pre-heating oxygen by indirect heat exchange against said first portion to form pre-heated oxygen and cooled water; and
combining at least a portion of said pre-heated oxygen with said second portion to form a SCW/O₂ fluid mixture before reacting said SCW/O₂ fluid mixture with said carbonaceous material in said first reaction zone.

11. The process according to claim 10 wherein at least a portion of said cooled water is recycled to form SCW.

12. The process according to claim 9 comprising:
reducing the pressure of said aqueous fluid mixture to form a multi-phase fluid mixture; and
separating said multi-phase fluid mixture into a fuel gas fraction; a liquid hydrocarbon fraction; a heavy hydrocarbon oil fraction; and a water fraction,
wherein at least a portion of said water fraction is recycled to produce SCW.

13. The process according to claim 1 comprising:
forming a slurry of pulverized coal and water;
pressurizing at least a portion of said slurry to form pressurized slurry;
dividing said pressurized slurry into a first portion and a second portion;
using said first portion as said carbonaceous material; and
mixing said second portion with said first supercritical fluid mixture or said supercritical fluid mixture derived therefrom.

14. The process according to claim 13 wherein the slurry is pre-heated to no more than 570K.

15. The process according to claim 1 wherein said first supercritical fluid mixture comprises solid particles of ash entrained therein, said process comprising separating ash particles from said first supercritical fluid mixture to form separated ash particles and particle-free, first supercritical fluid mixture which is mixed with said coal.

16. The process according to claim 1 wherein at least a portion of the heat required to react said carbonaceous material with said SCW is provided by pre-heating said SCW to at least about 1020K.

17. The process according to claim 1 wherein the process is carried out in a continuous flow reactor system, said process comprising operating said reactor system in a cycle, said cycle comprising an “on-line” phase in which said carbonaceous material and coal is converted into hydrocarbon compounds, and an “off-line” phase in which solid carbon-based material deposited within the reactor system is removed by combustion in a flow of SCW and oxygen.

18. A reactor system for producing hydrocarbon compounds from coal, said reactor system comprising:
a source of SCW;
a first reaction zone for reacting carbonaceous material with SCW at a temperature from at least 850K to produce a first supercritical fluid mixture comprising hydrocarbon compounds;
a mixing zone for mixing coal with at least a portion of said first supercritical fluid mixture or a supercritical fluid mixture derived therefrom to form a supercritical fluid reaction mixture at a temperature within a range from the supercritical temperature of water to about 695K; and
a second reaction zone for maintaining said supercritical fluid reaction mixture within said temperature range for sufficient time to extract hydrocarbon compounds from said coal and produce a second supercritical fluid mixture comprising hydrocarbon compounds.

19. The reactor system according to claim 18 comprising a first solid particle separator for separating ash particles from said first supercritical fluid mixture to produce separated ash and particle-free, first supercritical fluid mixture.

20. The reactor system according to claim 18 comprising a second solid particle separator for separating char particles from said second supercritical fluid mixture to produce separated char particles and particle-free, second supercritical fluid mixture.

21. The reactor system according to claim 20 comprising a conduit for feeding separated char particles from said second solid particle separator to said first reaction zone.

22. The reactor system according to claim 20 comprising:
a first heat exchanger for heating pressurized water by indirect heat exchange against particle-free, second supercritical fluid mixture to produce SCW and an aqueous fluid mixture comprising said hydrocarbon compounds;
a conduit for feeding SCW from said first heat exchanger to said first reaction zone; and
a conduit for feeding particle-free, second supercritical fluid mixture from said second solid particle separator to said first heat exchanger.

23. The reactor system according to claim 20 comprising:
a second heat exchanger for pre-heating oxygen-containing gas by indirect heat exchange against SCW to produce pre-heated oxygen-containing gas and cooled water; and
a conduit for feeding pre-heated oxygen-containing gas to said first reaction zone.

24. The reactor system according to claim 18 comprising a nozzle for injecting and rapidly mixing CWS into said first supercritical reaction mixture or said supercritical reaction mixture derived therefrom in said mixing zone.
